(19) United States
(12) Patent Application Publication
(10) Pub. No.: US 2015/0053387 A1
(43) Pub. Date: Feb. 26, 2015

(54) LINE WITH ARCHED STRUCTURE

(71) Applicant: WITZENMANN GMBH, Pforzheim (DE)

(72) Inventors: Marcel Horgos, Keltern (DE); Michael Pluschke, Neuenburg (DE); Bernd Seeger, Pforzheim (DE)

(73) Assignee: WITZENMANN GMBH, Pforzheim (DE)

(21) Appl. No.: 14/468,938

(22) Filed: Aug. 26, 2014

(30) Foreign Application Priority Data
Aug. 26, 2013 (DE) 102013109199.7

(51) Int. Cl. F16L 9/00; F28F 1/00

(52) U.S. Cl. CPC F16L 9/006; F28F 1/00
USPC 165/177; 138/177

(57) ABSTRACT

A line is provided for hot gas, for the use particularly in a motor vehicle with an internal combustion engine, with the line including at least one guiding pipe (2), having deformations (4) over at least a portion of its length at least over parts of its circumference, which seen from an exterior of the guiding pipe (2) are embodied convexly or concavely and are interrupted at least once in the circumferential direction.

### INCORPORATION BY REFERENCE

The following documents are incorporated herein by reference as if fully set forth: German Patent Application No. 10 2013 109 199.7, filed Aug. 26, 2013

### BACKGROUND

The invention relates to a line for hot gas (hot gas line) for a motor vehicle with an internal combustion engine.

In every construction of equipment or vehicles of any kind, particularly motor vehicles and airplanes, the total weight is of increasing importance today. For example in motor vehicles with an internal combustion engine the weight not only directly influences the fuel consumption but furthermore the emissions, and by increasingly stricter regulations their emission shall be further reduced.

In general, a reduction of the weight of individual components can be achieved by material savings and/or replacing heavy materials with lighter materials. When the materials cannot be beneficially replaced due to prices or other factors, it can be attempted to reduce the weight by a reduction of the wall thickness of parts, pipes, etc., or by a frame construction of load-bearing parts, for example. This can save resources and in general lead to energy savings by the reduced weight of the driven vehicles.

In particular in motor vehicles with an internal combustion engine or hot gas facility lines conducting hot gas, such as exhaust gas after the combustion, are generally embodied relatively thick, so that the pipes are not excessively stressed thermally and their strength is not reduced during operation. In order to reduce the thermal dissipation over the pipes towards the environment increasingly the exhaust lines of motor vehicles with internal combustion engines are insulated, because it is desirable for the post-treatment of the exhaust to prevent that its temperature drops excessively. This additional insulation leads to more undesired weight, which has negative effects upon the fuel consumption and the emissions.

When pipeline elements, particularly for exhaust applications, were embodied rather thin, frequently for the purpose of stabilization corrugations of relatively minor extent are integrated in smooth tubular sections of the above-mentioned pipeline elements. However, such reinforcements have only very localized effects and correspond to relatively large unreinforced sections of the pipeline elements. Additionally, cases develop in which the above-mentioned pipeline elements during operation exhibit an unpleasant howling due to low resonance frequencies.

### SUMMARY

Accordingly the objective of one aspect of the invention is to provide a pipe or a line, through which particularly hot gas can be conducted without any or with only little loss of heat and pressure, with the line being lighter than pipes or lines of prior art. Additionally, unpleasant noise developments shall be avoided.

This objective is further attained in a line featuring one or more aspects of the invention. Additional embodiments of the invention are described below and in the claims. They may be combined with each other in a technologically beneficial fashion. The description, particularly in the context with the drawings, additionally characterizes and specifies the invention.

One aspect of the invention relates to a line for hot gas for a motor vehicle with an internal combustion engine, with the line comprising at least one guiding pipe which has deformations over at least a portion of its length, preferably over its entire length, at least over portions of its circumference, which are embodied convexly or concavely, seen from the outside of the guiding pipe, and which are interrupted in the circumferential direction at least once in order to this way improve and/or allow improving the stiffness of the guiding pipe.

The feature “interrupted in the circumferential direction at least once” separates the claimed deformations from the stabilizing corrugations of prior art, which are embodied continuously (circularly) in the circumferential direction.

The line is therefore suitable for the use in a motor vehicle and can be provided for use therein. The term “guiding pipe” in general represents a synonym for the term “pipe” and only when it represents a single pipe, it means that the hot gas mandatorily flows in this pipe.

The deformations can be formed into the pipe for example via a respective tool by way of embossing or by an exterior pressure or by an interior pressure, with the tool predetermining the extent of the deformations.

The deformations serve to improve the stiffness of the guiding pipe in reference to a smooth pipe, for example. The deformations extend preferably over the entire length of the guiding pipe, at least over a portion of its circumference. However, they may also be formed particularly over the entire length and over the entire circumference of the guiding pipe in order to achieve a maximally possible reinforcement of the guiding pipe by the deformations. Here, several deformation are located behind each other and/or beside each other in the circumferential direction so that the deformation overall is embodied interrupted at least once in the circumferential direction.

The deformations may have an arched structure, which is formed by spaced apart, located side-by-side or abutting annular, comb-shaped, or net-shaped elements. The comb-shaped structure is particularly well suited to increase the stiffness of the guiding pipe. The shape and size of the combs may vary depending on the diameter of the guiding pipe, for example the size and the dimension of the convex and/or concave curves of the combs may increase with a growing diameter of the guiding pipe. This way it is simultaneously possible with the same functionality to reduce the quantity of material used and to save (transportation) weight.

The deformations may be embodied identical in reference to each other, however this is not mandatory.

Compared to a smooth material, the reinforced arched structures shift the resonance frequency to higher frequency ranges upon acoustic excitation. This way the humming of thin-walled components (e.g., air ducts), which is frequently experienced as unpleasant, is reduced. Simultaneously the material with curved structures shows improved damping characteristics, which reduces the emitting of impact sound.

In a convex embodiment of the arches the diameter of the guiding pipe with an arched structure is greater than in case of a concave embodiment. Therefore when the guiding pipe is to be used in an area with structural space being critical, it is advantageous to reinforce the guiding pipe with concave arches, which may lead to a surface structure of the line which is embodied similar to the surface of a golf ball. An example for an area in which structural space is critical is for example an internal combustion engine and the exhaust system of a motor vehicle connected thereto.

With regards to a longitudinal axis and/or a circumference of the line the deformation may be arranged and/or embodied symmetrically. Preferably all individual deformations (recesses or bulges) may be embodied identically and arranged regularly without the invention being restricted thereto, though. Here, an off-set positioning of the deformations in reference to each other is also possible, depending on the longitudinal arrangement. The off-set may here be regular, in particular.

The guiding pipe may be a thin-walled pipe with a wall thickness of more than 0.2 mm and less than 0.8 mm, particularly less than or equivalent to 0.5 mm. Particularly in the construction of vehicles and airplanes here weight can be reduced, which directly has positive effects upon the fuel consumption and thus also the emission of harmful substances.

The suggested thin-walled guiding pipe can particularly replace an exhaust pipe of a motor vehicle, which generally shows a wall thickness of approx. 2 mm to 3 mm.

Such a thick-walled pipe exhibits a relatively high thermal capacity, relatively poor insulating characteristics, and due to its generally smooth-walled embodiment, it also shows a relatively unpleasant resonance behavior.

The thin-walled pipe with deformation exhibits however, due to its increased rigidity, an improved resonance behavior and the weight reduction that can be achieved is considerable, ranging from 60% to more than 80%.

The line may comprise a second pipe, which surrounds the guiding pipe or itself is surrounded by a guiding pipe. The line can consequently represent a double-walled line having an internal pipe and an external pipe. Here, the hot gas can flow in the internal pipe, which not necessarily represents the guiding pipe, but the second pipe may also represent it as well, according to the common use of the term in the present invention.

This sandwich structure is completely flexible in its embodiment and thus shows advantages with regards to the guiding flux of the gas flowing in the line or around the line, the acoustics, the thermal insulation, and the aspect of weight reduction. Experiments have shown that thick-walled pipes guiding hot gas, (which) can be replaced by the multi-layered embodiment described here, without any disadvantages developing in the function.

Acoustically, due to their modular friction, multi-layered pipes are always better than single-layer pipes showing the same wall thickness, with the single-layer pipe comprising a wall thickness which is at least equivalent to the added thickness of all pipes of the multi-layered line. The curved structure yields a considerably better reinforcement of the surface, which further improves the acoustic.

The second pipe may represent another pipe with deformations, a plain pipe, or a so-called liner (metallic wound pipe). A normal pipe with a smooth circumference, i.e. a circumference free from any curvatures or other deformations, is called a plain pipe. In the present case the liner is called a pipe when, together with the guiding pipe, it forms the line for the hot gas and here surrounds the guiding pipe or is arranged inside the guiding pipe.

The second pipe and the liner, respectively, may surround the guiding pipe in which the hot gas flows. Alternatively the guiding pipe may surround the second pipe or the liner. In this case the hot gas flows in the second pipe or the liner, respectively.

Similar to the guiding pipe, the second pipe can represent a thin-walled pipe with a wall thickness of more than 0.2 mm and less than 0.8 mm, particularly less than or equivalent to 0.5 mm.

This sandwich construction provides considerable weight advantages in reference to thin-walled plain pipes. Due to the double-walled structure of the line additionally in particular an improved acoustic damping and improved thermal insulation of the line is achieved.

The internal pipe or the inner pipe of the line, representing here either the guiding pipe or the second pipe/liner, can abut with its exterior circumferential area an interior circumferential area of the exterior pipe or the external pipe of the line. Consequently the internal diameter of the exterior pipe can essentially be equivalent to the exterior diameter of the interior pipe, i.e. except for the common production tolerances.

In the pipe with the deformations here the interior diameter always represents the shortest distance between interior walls of the pipe, which directly oppose each other in reference to a central longitudinal axis of the pipe, respectively the exterior diameter representing the largest distance between the exterior walls of the pipe located opposite each other with regards to the central axis of the pipes.

The two pipes preferably are not abutting each other in a planar fashion, but sections are formed by arches of the guiding pipe and/or the second pipe, at which the two pipes contact each other and therebetween generally large regions are provided in which the pipes are spaced apart from each other.

These hollow cavities or air pockets may be filled with air or an insulating material and thus further reduces any thermal dissipation from the internal pipe towards the exterior one. Simultaneously, noise-insulation of the line is yielded by the double-walled pipe and the rigidity of the pipe is further improved.

An exterior diameter of the internal pipe may also be so small that a circumferential gap is formed in a centered arrangement of the internal pipe inside the exterior pipe.

In order to arrange the interior pipe radially, essentially concentrically, in the exterior pipe the second pipe and/or the guiding pipe may include spacers. These spacers may be connected to the second pipe and/or to the guiding pipe and fix the internal pipe in the exterior pipe in an essentially centered fashion. Alternatively the spacers may also be embodied as separate elements.

Alternatively the internal pipe and the external pipe may show a plain end at either side, preferably compressed with each other, i.e. connected in a force-fitting fashion, so that the interior pipe is arranged essentially concentrically in the exterior pipe, with both pipes showing the same central longitudinal axis. Additionally the pipe ends may be adhesively connected, for example by a subsequent spot welding or by a hard soldering means, upon compression at an appropriate temperature. An additional adhesion of the ends to each other is also possible when the conditions at the pipe ends during operation, for example a maximum temperature, allow this.

When a gap is formed between the guiding pipe end and the second pipe, a thermally insulating material may be arranged in this gap. This way, the use of any spaces can be waived, particularly when the insulating material completely fills out said gap.

The insulating material may represent an insulating mesh, for example an aluminum silicate film, or a ceramic or mineral material, for example fiberglass.

Alternatively, a wound hose with an arbitrary profile height may be arranged in the gap, which thermally insulates the pipe located inside from the pipe located outside. Here, the space between the adjacent windings of the wound hose may be filled with a thermally insulating material, and/or the windings may be mechanically processed for increased form stability, e.g. compressed.

With the wound hose as an additional insulating layer the acoustic characteristics and the thermal insulation of the line can be further improved in reference to a line showing (only) insulating material. The introduction of the third element provides additional rigidity and increases the acoustic impedance of the line. In particular, by the use of wound hoses with additional insulating material the temperature of the exterior surface of the line can be reduced to a desired low value and the cooling of the gas guided in the line can be reduced.

Another aspect of the invention relates to a motor vehicle with an internal combustion engine and a line for hot gases, with it being possible that the line for hot gases may represent particularly the line described above.

The line may be a part of an exhaust system of a motor vehicle, for example an exhaust pipe, which guides the exhaust of the combustion from the internal combustion engine to the catalytic converter or the like.

Another aspect of the invention relates to the use of the above-described line for the transfer of hot gas based on combustion or chemical reaction in the system. Such a system may represent for example a gas facility or a biogas facility. Facilities in which chemical reactions occur, which generate heat, are also considered, or the above-mentioned motor vehicle with an internal combustion engine. In general the above-described line may also replace thick-walled pipes, which are not guiding hot gas, but which for other reasons require a high level of rigidity, for example because repeatedly they are exposed briefly to high internal or external pressures.

Pipes subjected to high exterior pressures may represent pipes which are laid subsequently under railway tracks or roads, for lines crossing the railway track or road, etc.

Another aspect of the invention relates to the use of a line according to the invention based on the described embodiments, in a heat exchanger. Namely, the curved structures improve the heat exchange during the flowing of a fluid due to the constantly newly generated eddies (turbulences) of the fluid at the curved structures, preferably arranged off-set in the circumferential direction in reference to each other, depending on their position in the longitudinal direction (longitudinal position).

Preferably the curved structures have no sharp edges in another further development of the invention. Then, as well as preferably due to the potentially off-set arrangement (see above), which additionally may be embodied regularly, i.e. with equal off-setting, a central hydraulic resistance remains essentially homogenous in the line (compared to a plain pipe), so that here no disturbing loss of pressure occurs.

### BRIEF DESCRIPTION OF THE DRAWINGS

In the following, exemplary embodiments of the line are explained in greater detail based on the figures, with the invention not being limited to the exemplary embodiments shown. Technical features essential for the invention, which are only discernible from the figures, are included in the scope of the invention, and they may further develop the invention, either alone or in the combination shown.

For the entire description and the claims it shall apply that the expression “a” is used as the indefinite article and the number of parts is no limited to a single one. When “a” shall have the meaning of “only one”, this shall be understandable for one trained in the art from the context or it is disclosed unambiguously by the use of suitable expressions, such as “a single one”.

FIG. 1 shows a double-walled line comprising a plain pipe and a pipe with deformations;

FIG. 1A is an enlarged detail of a part of FIG. 1;

FIG. 2 shows the line of FIG. 1 with insulation;

FIG. 2A is an enlarged detail of a part of FIG. 2;

FIG. 3 shows the line of FIG. 2 with a wound hose as the insulation;

FIG. 3 A is an enlarged detail of a part of FIG. 3;

FIG. 4 shows a double-walled line comprising two pipes with deformations; and

FIG. 4A is an enlarged detail of a part of FIG. 4.

### DETAILED DESCRIPTION OF THE PREFERRED EMBODIMENTS

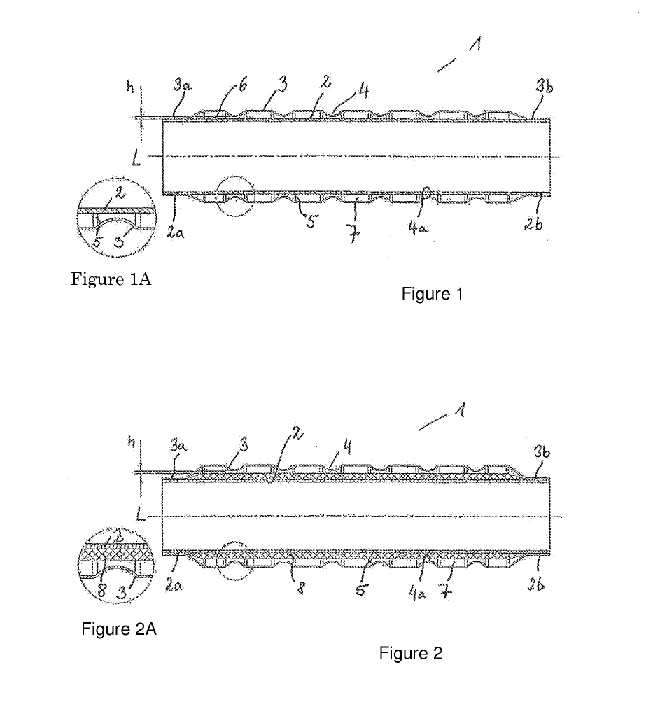

FIG. 1 shows in a longitudinal cross-section a first embodiment of a line 1 with a smooth-walled interior or guiding pipe 2 and an exterior or second pipe 3 with deformations 4 as well as an enlarged detail (FIG. 1A) of the longitudinal cross-section, which is symbolized by a circle.

Such enlarged details of the line 1 are also shown in FIGS. 2A to 4A. Due to the fact that these illustrations are self-explanatory, they are not described in detail in the description of the figures.

The interior pipe 2 according to FIG. 1 is arranged concentrically inside the exterior pipe 3, i.e. both pipes have an identical central longitudinal axis L. The deformations 4 represent concave annular indentations, which are spaced apart from each other in the longitudinal direction of the line 1 over the entire circumference of the exterior pipe 3 by way of embossing or implemented by way of an exterior pressure being applied.

Due to the deformations 4, which may also form for example honeycomb-shaped structures of the exterior pipe 3, the flexural strength of the exterior pipe 3 is improved in reference to a plain pipe with the same wall thickness.

The interior pipe 2 and the exterior pipe 3 show smooth-cylindrical end sections 2a, 3a; 2b, 3b, which can be compressed with each other in order to hold the interior pipe 2 concentrically in the exterior pipe 3.

In the exemplary embodiment shown, additionally spacers 5 may be inserted between the interior pipe 2 and the exterior pipe 3, which may prevent for example any bending of the interior pipe 2 due to high temperatures of a hot medium guided in the interior pipe 3. The spacers 5 may be connected in the exemplary embodiment particularly with the exterior pipe 3 in order to allow the insertion of the interior pipe 2 into the exterior pipe 3. If the interior pipe 2 showed the deformations and the exterior pipe 3 represented a plain pipe, it could be beneficial to connect the spacers 5 with the interior pipe 2.

Alternatively, the reference character 5 identifies simply the bending and/or curvature lines in the area of the deformations 4 of the exterior pipe 3, which even without spacers may show sufficient inherent rigidity.

A circumferential gap 6 is formed between the interior pipe 2 and the exterior pipe 3, preferably continuous in the longitudinal direction, which shows a gap width or height h, with the height h defining a minimum distance between the interior pipe 2 and the exterior pipe 3 except for the end sections 2a, 3a; 2b, 3b. In the sections of the exterior pipe 3 without any deformations 4 the distance between the interior pipe 2 and the exterior pipe 3 is greater than the gap width h, forming pockets or air pockets 7.

The height h may also be equivalent to zero so that the exterior pipe 3 with the deformations 4, respectively the front ends (apexes) 4a of the deformations 4 abutting the interior pipe 2. However, this leads to a thermal bridge between the interior pipe 2 and the exterior pipe 3 and thus, under certain circumstances, it has negative consequences for the insulating characteristics of the line 1.

The interior pipe 2 and the exterior pipe 3 may be produced from the same material or from different materials. For example, the interior pipe 2, in which the hot medium flows, may be formed from stainless steel for example, and the exterior pipe from aluminum alloy, which preferably shows essentially the same thermal expansion coefficient as stainless steel.

In the exemplary embodiment shown the gap 6 is filled with air. The layer of air with the height h forms insulation between the interior pipe 2 and the exterior pipe 3, which reduces any thermal flux from the hot medium flowing in the interior pipe 2 to the environment. Simultaneously the double-walled construction shows positive effects upon the acoustic characteristics of the line 1. For example it damps the noise level of the exhaust system in a motor vehicle with an internal combustion engine, when it conducts the gas after the combustion in the internal combustion engine to a catalytic converter or the like, and reduces its oscillation by the improved rigidity of the line 1.

The deformations 4 may additionally lower wind noise of the air flowing around the line 1 by an improved flow guidance and circulation, respectively.

The interior pipe 2 and the exterior pipe 3 may particularly represent thin-walled pipes showing a wall thickness from 0.2 mm to 0.8 mm. In particular, the walls may not be thicker than approximately 0.5 mm.

In order to achieve a similar rigidity with a single plain pipe, said pipe had to have a wall thickness from 2 mm to 3 mm. Accordingly, using the double-walled line 1 shown, compared to conventional plain pipes, here weight savings can be yielded of at least 50%, assuming a wall thickness of 0.5 mm for the interior pipe 2 and the exterior pipe 3 and comparing them with a plain pipe having a wall thickness of at least 2 mm.

FIG. 2 shows, similar to FIG. 1, a line comprising a plain interior pipe 2 and an exterior pipe 3 with deformations 4. An insulation material 8 is inserted between the interior pipe 2 and the exterior pipe 3, which further improves the thermal insulation of the line 1 from the environment and simultaneously increases its rigidity and acoustic impedance.

The insulation material may represent an insulation web, for example an aluminum silicate film, or a ceramic or mineral material, for example fiberglass.

A circumferential gap 6 with a gap width h is formed between the insulating material 8 and the exterior pipe 3. The (optional) spacers 5 (see above) hold the exterior pipe 3 in a concentric position in reference to the interior pipe 2 and the insulation 8 resting on the interior pipe 2 or being connected to the interior pipe.

As already explained regarding FIG. 1, the exterior pipe 3 and the apexes 4a of the deformations 4, respectively, can rest directly on the insulation 8, generally rendering the spacers 5 to become unnecessary. This way in turn a heat bridge is formed, which shows reduced thermal insulation characteristics in reference to the solution with the gap 6 and the insulating layer 8. The insulating layer 8 is held between the end sections 2a, 3a; 2b, 3b of the interior pipe 2 and the exterior pipe 3 preferably by way of a force-fitting connection.

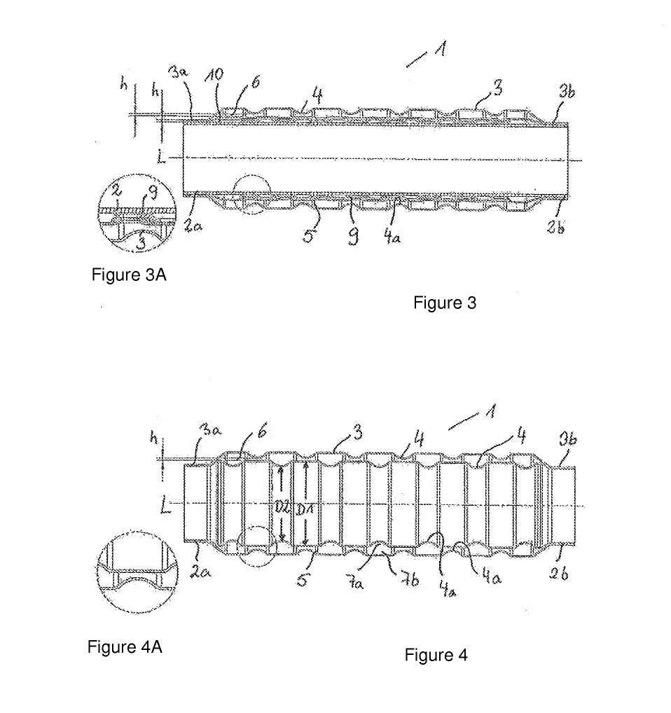

FIG. 3 shows the line of FIG. 2, in which the insulation 8 was replaced by another profiled line element, particularly a wound hose (liner) 9. By the use of a wound hose 9 as the insulation, for example two concentrically arranged gaps 6 and 10 are formed in the line, which may be filled with air and/or an insulating material. This way the line 1 of FIG. 3 can show even further improved insulating, rigidity, and acoustic values in reference to the line 1 of FIG. 2.

FIG. 4 shows an alternative embodiment of the line 1, in which the interior pipe 2 and the exterior pipe 3 show deformations 4, which are arranged off-set in reference to each other in the longitudinal direction of the line.

In this line 1 the gap 6 is formed with a gap width h between a maximum diameter D1 of the interior pipe 2 and a minimum diameter D2 of the exterior pipe 3. This way air pockets 7a and 7b develop, which are positioned opposite each other and are connected by the gap 6. These expanded air pockets 7a, 7b can particularly further improve the acoustic impedance of the line 1, in particular.

By the use of an interior pipe 2 with deformations 4 and an exterior pipe 3 with deformations 4 the rigidity of the line 1 can be even further increased in reference to the embodiment of FIG. 1, which has positive effects particularly upon the oscillation behavior of line 1.

In this embodiment as well, insulation material may also be inserted between the interior pipe 2 and the exterior pipe 3, as shown in FIGS. 2 and 3.

Although in the above description some potential embodiments of the invention have been disclosed, it shall be understood that numerous additional variants of embodiments exist by way of possible combinations of all of the above-mentioned technical features and forms of embodiments as well as those obvious for one trained in the art. It shall further be understood that the exemplary embodiments only represent examples, which in no way restrict the scope of protection, potential applications, and the configuration. Rather, the above-stated description shall provide one trained in the art with a suitable path to implement at least an exemplary embodiment. It shall be understood, though, that in an exemplary embodiment numerous changes can be implemented with regards to function and arrangement of the elements without leaving the scope of protection disclosed in the claims and their equivalents.

### LIST OF REFERENCE CHARACTERS

1 Line
2 Interior pipe, guiding pipe
2a End section
2b End section
3 Exterior pipe, second pipe
3a End section
3b End section
4 Deformation
4a front end of deformation
5 Spacer
6 Gap
7 Air pocket
7a Air pocket
7b Air pocket
8 Insulation, insulating material
9 Wound hose, liner
10 Gap
L Central longitudinal axis
h Gap height, height
D1 Diameter
D2 Diameter

1. A line for hot gas, comprising at least one guiding pipe (2) having a length and a circumference, with deformations (4) formed at least over parts of the circumference and over at least a part of the length, the deformations are embodied convexly or concavely, seen from an exterior of the guiding pipe (2), and are interrupted at least once in a circumferential direction.

2. The line according to claim 1, wherein the deformations (4) form an arched structure of spaced apart or side-by-side located or abutting annular, honey-comb shaped, or web-shaped elements.

3. The line according to claim 2, wherein the deformations (4) are arranged or embodied symmetrically in reference to at least one of a longitudinal axis or the circumference of the line.

4. The line according to claim 1, wherein the guiding pipe (2) comprises a thin-walled pipe with a wall thickness of more than 0.2 mm and less than 0.8 mm.

5. The line according to claim 1, wherein the line (1) comprises a second pipe (3) which surrounds the guiding pipe (1) or is surrounded by the guiding pipe (1).

6. The line according to claim 5, wherein the second pipe (3) comprises a plain pipe or a wound hose (9).

7. The line according to claim 5, wherein the second pipe (3) comprises a thin-walled pipe with a wall thickness of more than 0.2 mm and less than 0.8 mm.

8. The line according to claim 5, wherein the interior pipe (2) includes an exterior circumferential area abutting an interior circumferential area of the exterior pipe (3) or a maximum diameter of the interior pipe (2) is smaller than the exterior pipe such that a gap (6) is formed between the interior pipe (2) and the exterior pipe (3).

9. The line according to claim 1, wherein the interior pipe (2) is arranged in the exterior pipe (3) essentially concentrically.

10. The line according to claim 9, further comprising an insulation (8) comprising an at least one of thermally or acoustically insulating material is arranged between the interior pipe (2) and the exterior pipe (3).

11. The line according to claim 9, further comprising a wound hose (9) arranged between the interior pipe (2) and the exterior pipe (3).

12. A motor vehicle with an internal combustion engine and the line (1) for hot gas formed according to claim 1.

13. The motor vehicle according to claim 11, wherein the line (1) is a part of an exhaust system of the motor vehicle.

14. The line (1) according to claim 1, wherein the line is a part of a heat exchanger.
